(19) United States
(12) Patent Application Publication
(10) Pub. No.: US 2026/0013424 A1
(43) Pub. Date: Jan. 15, 2026

(54) Remote Controlled Lawn Mower With Tread System

(71) Applicant: Jason Heitz, Normal, IL (US)

(72) Inventor: Jason Heitz, Normal, IL (US)

(21) Appl. No.: 18/767,912

(22) Filed: Jul. 9, 2024

Related U.S. Application Data
(60) Provisional application No. 63/525,696, filed on Jul. 9, 2023.

(51) Int. Cl. A01D 34/00; A01D 101/00

(52) U.S. Cl. CPC A01D 34/008; A01D 2101/00

(57) ABSTRACT

The remote-controlled lawn mower uses a unique rubber track system which allows for the lawn mower to handle much steeper gradients than previously available. The multiple track system allows for a plurality of treads to grip into the ground in ways that other lawnmowers are unable. This allows the remote-controlled lawn mower to handle slopes as steep as 45 degrees.

### CROSS REFERENCE TO RELATED APPLICATIONS

This application claims the benefit of U.S. Provisional Application Ser. No. 63/525,696, filed on Jul. 9, 2023, which is hereby incorporated by reference in its entirety.

### FIELD OF INVENTION

The present invention concerns agricultural machines. More particularly, the invention is directed to a remote controlled lawn mower which is particularly adept at traversing slopes.

### BACKGROUND OF THE INVENTION

Remote controlled lawn mowers have been around for a while, and recent technological upgrades have made them more affordable and practical than ever. A problem with mowing is mowing steep slopes. As a lawn mower is a heavy piece of equipment, it is easy for an operator to lose control of the mower, which can result in very grave injuries. Some sloped yards are planted with ivy or other low maintenance ground cover, but the problem with that is pests can hide under the thick cover. Also, weed can invade the ground cover. Finally, the aesthetic of the alternative ground cover does not appeal to all homeowners.

### SUMMARY OF THE INVENTION

The present invention is directed to a remote controlled lawnmower apparatus. The apparatus includes a control unit for receiving transmissions from a remote control device. The mower uses rubber covered tracks in place of wheels. The drive arrangement allows for increased stability on slopes as well as increased control relative to a wheeled vehicle as steerable wheels are not required.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention. As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software.

As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

It is an object of the invention to provide a lawn mower with a unique rubber track system which allows for the lawn mower to handle much steeper gradients than previously available.

It is an object of the invention to provide a lawn mower with a multiple track system which allows for a plurality of treads to grip into the ground in ways that other lawnmowers are unable. This allows the remote-controlled lawn mower to handle slopes as steep as 45 degrees.

### BRIEF DESCRIPTION OF DRAWINGS

FIG. 1 shows a back perspective view of a remote-controlled lawn mower.

FIG. 2 shows a front perspective view of a remote-controlled lawn mower.

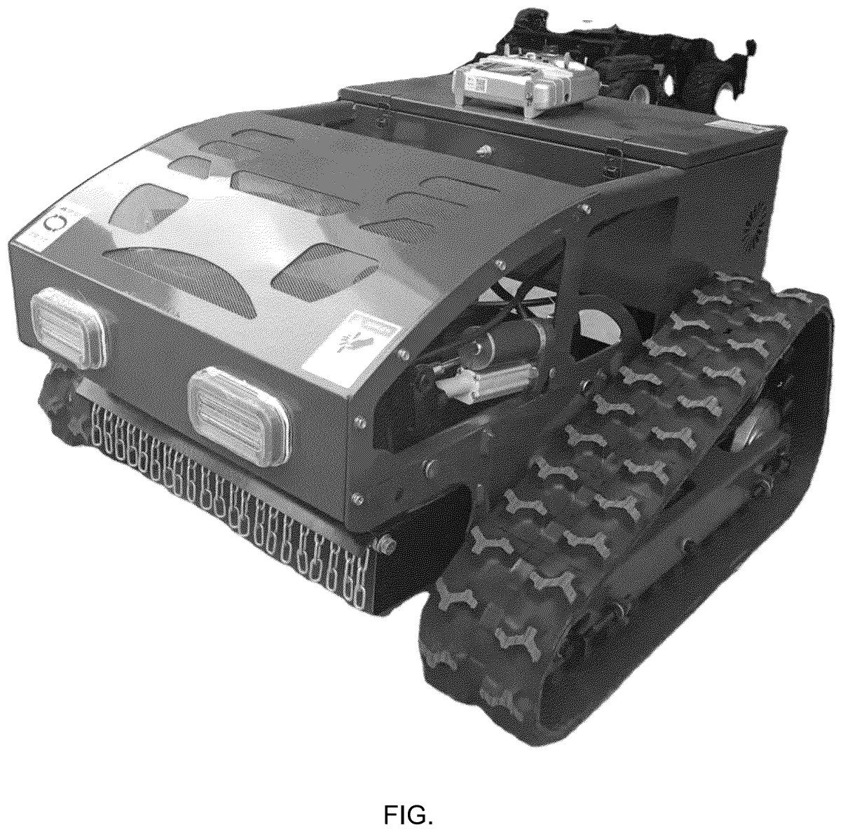

FIG. 3 shows a front perspective view of a remote-controlled lawn mower.

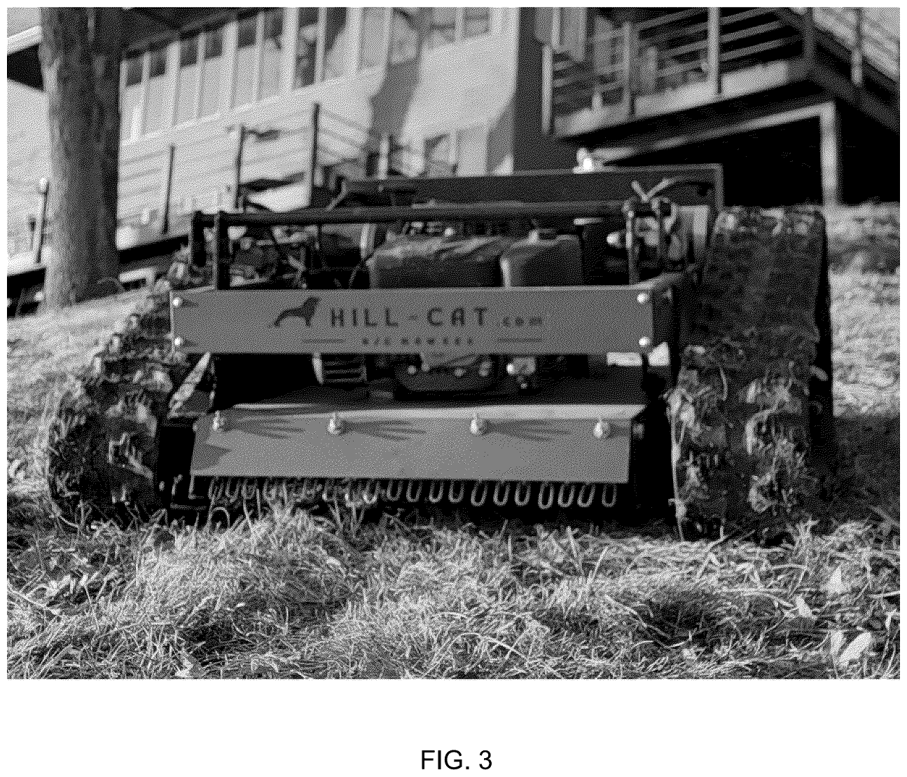

FIG. 4 shows a side view of a remote-controlled lawn mower.

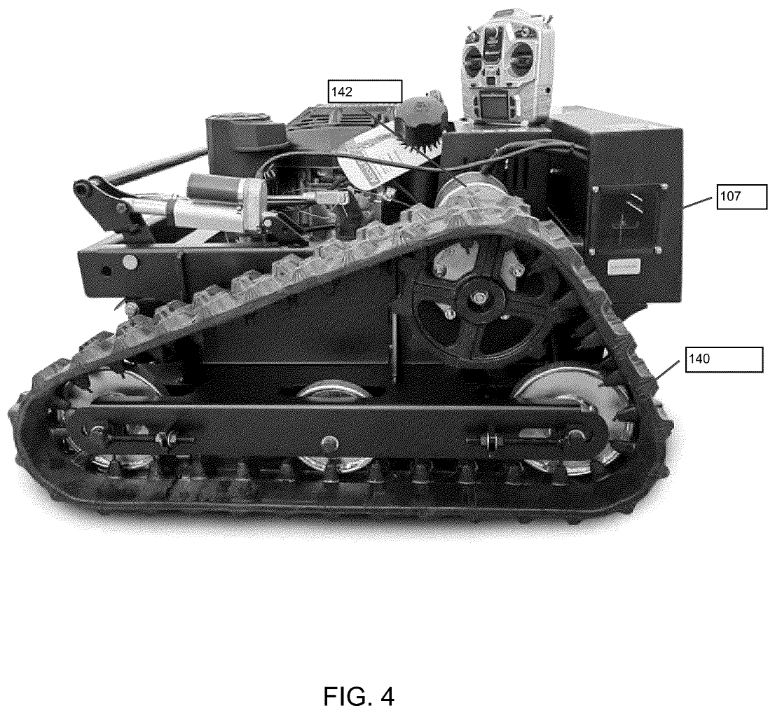

FIG. 5 shows a back view of a remote-controlled lawn mower with physical controls such as start, stop, and the power charging port.

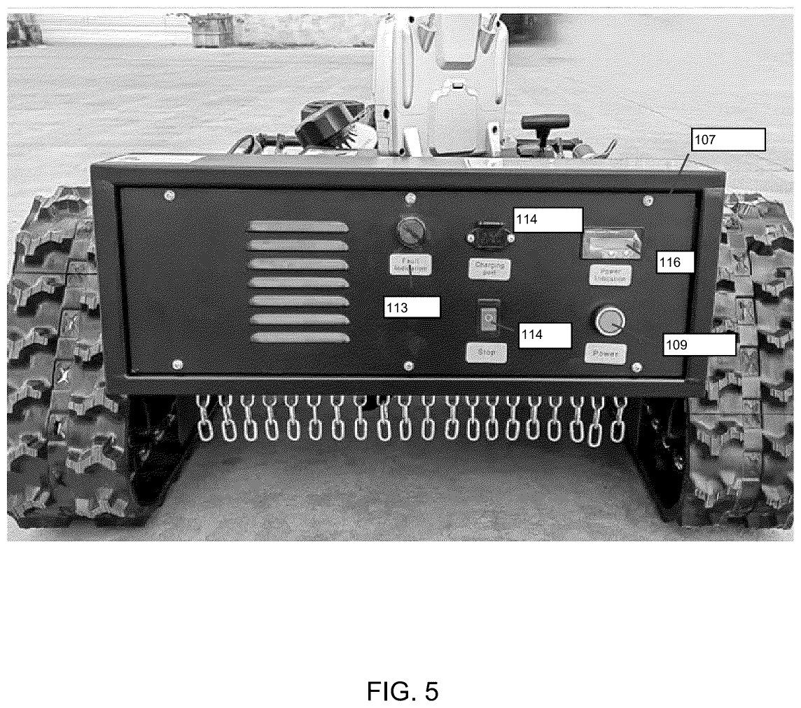

FIG. 6 shows a front perspective view of a remote-controlled lawn mower.

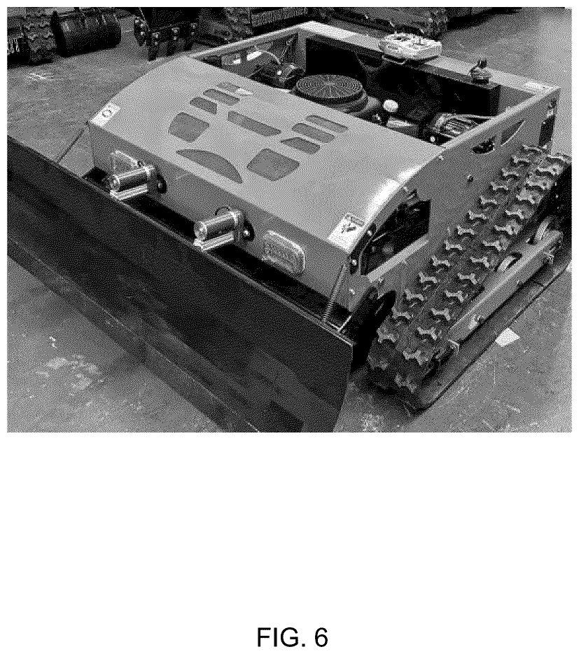

FIG. 7 shows a side perspective view of a remote-controlled lawn mower.

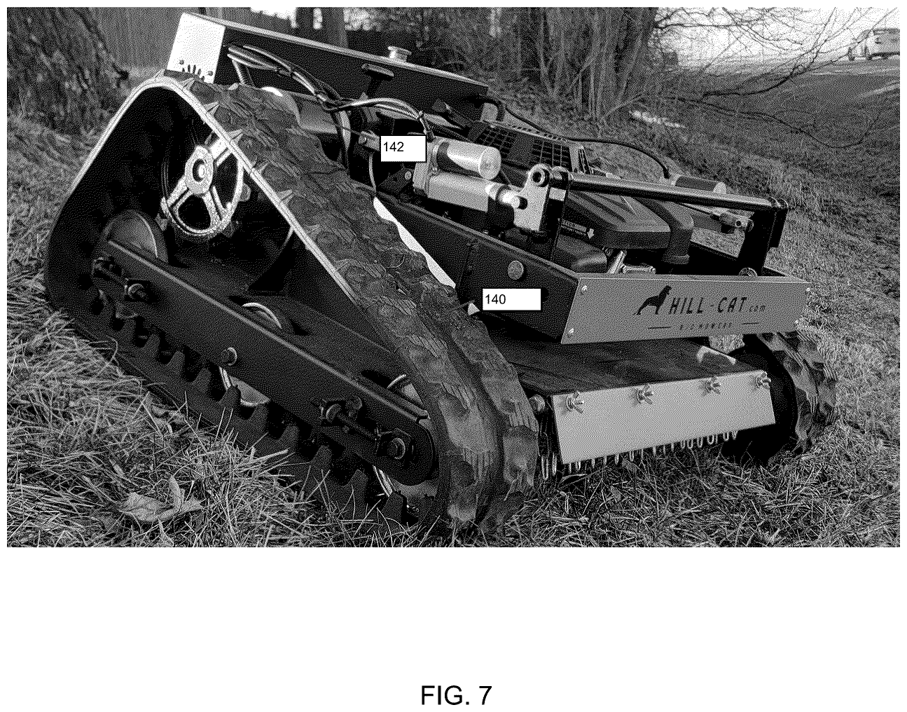

FIG. 8 shows a front perspective view of a remote-controlled lawn mower with the controller.

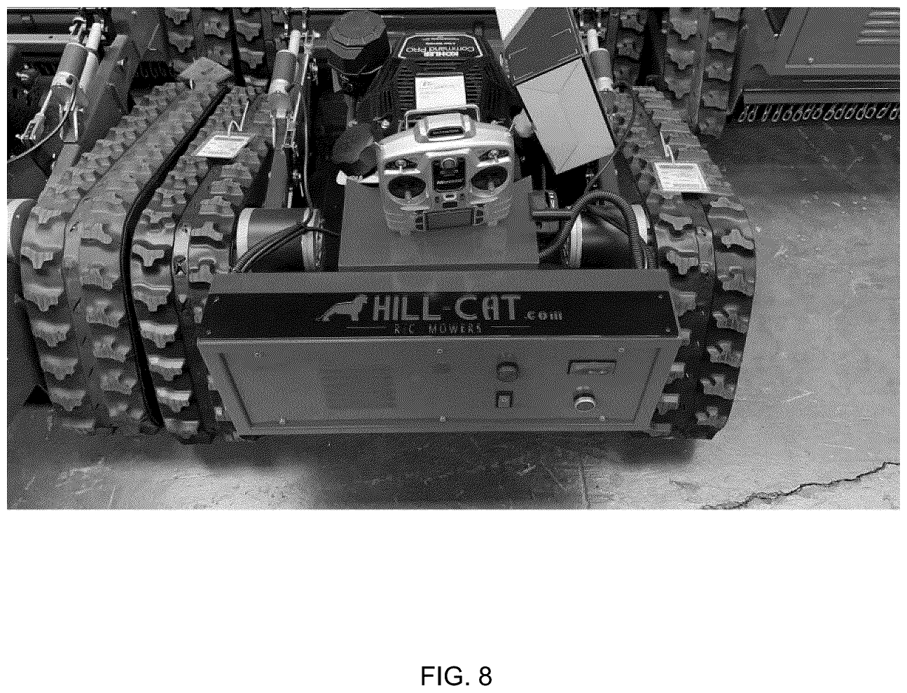

### DETAILED DESCRIPTION OF THE INVENTION

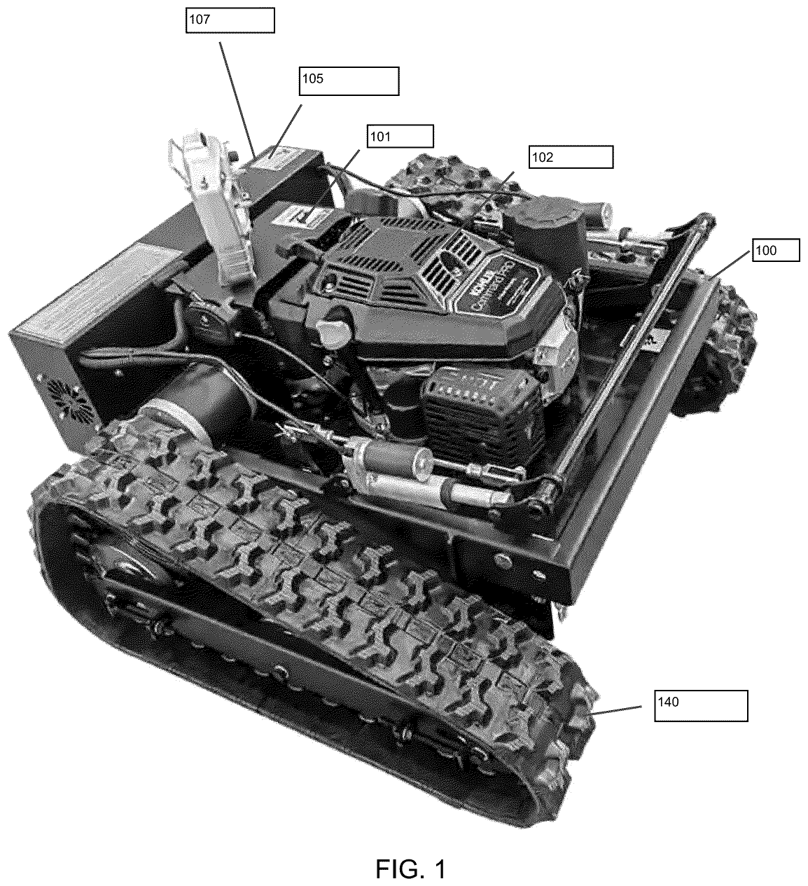

Referring to FIG. 1, the disclosure provides a self-propelled lawn mower 100. The lawn mower 100 includes a housing 101, a track supported the lawn mower 100, a self-propelled motor 102 which is configured to drive the tracks 104 to self-propel, a control circuit board 105 which is configured to control turning-on and turning-off of the self-propelled motor and an enclosure which is assembled with the housing 101.

A blade and a motor for driving the blade to rotate are arranged in the housing 101, a power assembly is formed by the blade and the motor 102. The blade arranged at the bottom of the housing 101 is rotatable along a rotating shaft perpendicular to a ground to mow grasses on the ground. A power supply assembly (not shown) is also arranged in the housing 101, and the power supply assembly is configured to supply power to the lawn mower 100 to ensure that the grasses are mowed effectively.

A key aspect of the invention is the use of tracks in lieu of wheels to propel the mower. The tracks 140, which are preferably rubberized with rubber over a metal linkage, are independently motivated by way of the circuit board 105 sending control signals to the track drive motor 142. Steering is accomplished by selectively driving the tracks in the well known manner. Thus, steering is more accurate and less likely to be affected by uneven or overgrown terrain.

A separate housing 107 is provided for the control circuit 105. The housing 107 keeps the circuits watertight so that rain or moisture cannot interfere with operation of the mower 100. The housing includes a power switch 109, a charging port 112, a fault indicator light 113, an emergency stop switch 114, and a power indicator lamp 116.

A remote control (not shown) is used to send control signals to the circuit board 105. The control signals would include stop, go, left right etc., as well as reverse for tight spaces.

1. A lawn mower, comprising:
a. a housing;
b. a pair of opposing tracks for motivating and supporting the lawn mower;
c. a motor for driving the opposing tracks to propel the lawn mower;
d. a control circuit board for controlling the motor;
e. a remote control for sending control signals to the control circuit,
wherein, the opposing tracks are operated to propel and steer the mower by selective application of power.
